(19) United States
(12) Patent Application Publication
(10) Pub. No.: US 2011/0004544 A1
(43) Pub. Date: Jan. 6, 2011

(54) ENVIRONMENTAL AUDIT METHOD

(76) Inventor: Diane T. Baum, Baton Rouge, LA (US)

Correspondence Address: KEAN, MILLER, HAWTHORNE, D'ARMOND,;MCCOWAN & JARMAN, L.L.P., ONE AMERICAN PLACE, 22ND FLOOR, P.O. BOX 3513, BATON ROUGE, LA, 70821, US

(21) Appl. No.: 12/783,173

(22) Filed: May 19, 2010

Related U.S. Application Data
(63) Continuation-in-part of application No. 10/824,056, filed on Apr. 14, 2004, now abandoned.
(60) Provisional application No. 60/463,597, filed on Apr. 17, 2003.

(51) Int. Cl. G06Q 40/00

(52) U.S. Cl. 705/38

(57) ABSTRACT

A method for performing an environmental audit to accompany commercial loan transactions, residential loan transactions, and other loan transactions or review is disclosed. The audit requires the evaluation of the environmental risk associated with a service or piece of real property. Although not all may apply to a given transaction, the evaluation considers the following criteria: property, service operation, current compliance, and future compliance. The report may also include an explanation of any low scores, recommendations, other notes, and a section covering liabilities and limitation. The invention also includes a method to be used by a single environmental auditing firm for employing the disclosed environmental auditing method in all loan transactions generated by one or more financial institutions.

### CROSS REFERENCE TO RELATED APPLICATION

This Application is a continuation in part of U.S. application Ser. No. 10/824,056, filed on Apr. 14, 2004, which claims priority to U.S. Provisional Application Ser. No. 60/463,597, filed on Apr. 17, 2003.

### STATEMENT REGARDING FEDERALLY SPONSORED RESEARCH OR DEVELOPMENT

Not Applicable

### REFERENCE TO A “SEQUENCE LISTING,” A TABLE, OR A COMPUTER PROGRAM

Not Applicable

### SUMMARY OF THE INVENTION

The present invention discloses a method of performing an environmental audit and summarizing the results in an easily understandable format. The method includes a business service that is offered to banks and other clientele as an environmental audit report with a score that will detail current environmental problems and will assist in curtailing future problems in understanding and limiting environmental risk. The audit report may be established directly in response to a customer's request for an audit, or in response to a request for a commercial, residential, or other loan application renewals, general reviews and/or extensions of credit. It may be paid for by the client through established closing costs within the loan transactions, when applicable. These costs would raise the closing costs a small amount, when compared to other kinds of reports, and could be kept to a minimum if the bank wishes to take advantage of economies of scale by having a single auditing firm perform environmental audits for all customers of a single bank. The report also minimizes the bank, other lender, or customer's time spent evaluating the risks associated with a business or property site. The exact cost associated with an environmental audit depends on the regional area, the volume of audits being performed, type of parameters reviewed, and other factors.

The disclosed method includes, but is not limited to, the following features: a report with a “score” of environmental risk pertaining to four set standards, namely property, service, compliance, and future compliance obligations; accounts are set up with banks as partners and with local offices in each state; a report is included as a standardized review practice as a liability review of closing costs and provided to the client, which may generate future work and/or provide incentives to the client future to solicit work on the property in question; and reports are more acceptable because of the lowered costs, fee income, faster review time, automated services via website and standardized review process.

The environmental audit report generated by the invention may be used on a frequent basis and on a standardized review template process. This process is typically integrated into the various parameters used currently to gauge risk of a site or business (i.e. appraisal, credit score, etc.) For example, the method of the invention may be used in connection with all loan transactions across the board for a single bank, thus decreasing costs to banking customers and/or the bank client, who would otherwise be charged independently for each standardized or customized audit.

### BRIEF DESCRIPTION OF THE DRAWINGS

FIG. 1 is an example report generated according to the present invention.

FIG. 2 is a report production schematic.

FIG. 3 is a chart showing how services according to the present invention may be charged.

FIG. 4 is a comparison of existing environmental audit methods to the present invention.

FIG. 5 is an example final report generated according to the present

### DETAILED DESCRIPTION OF THE INVENTION

The method according to the invention is the result of a focused effort to streamline the process by which lenders identify environmental liabilities without having to thoroughly understand the associated body of environmental laws and technical regulations. The method involves producing an environmental report that provides an easy-to-understand numerical, alphabetical, or colorful “score” as a feature of the report. The actual algorithm for converting a set of information into an appropriate score is not crucial to the invention, as any number of methods are equally viable. Dependent on the client, different parameters and risk tolerances may apply to the algorithm without limiting the statistical basis to compare all models on a single platform. The scores are representative of the environmental risk associated with a given property and/or service and are consistently used in each application of the invention.

The practical information in the auditing report benefits the bank (or other lender) by providing liability dissipation and is an enhanced service to the bank client, because it provides a broadened concept of the ways in which a company can maintain compliance with environmental regulations. The current method provides liability to the extent of the search and limits the liability as would a search performed by an independent title company or appraisal. Algorithms and scores are adjusted based on the regulatory environment, adjusting for regulatory code changes and adjustments in liability conditions as they present themselves. Therefore, the score is dynamic and is adjusted accordingly to adapt to liability concerns and risks at the time the services are requested.

The invention offers a solution to a problem that is prevalent in today's litigious arena, which has forced banks, bank customers, and service providers to become familiar with the ever-expanding environmental programs and regulations. The invention takes technical information, digests the technical information into a simplified format, and transforms the information into a simplified format available to small firms, thus providing a value added service to bank customers. It also allows banks to increase their fee income profits on closing costs associated with the loan and limits the bank's liability on its insurance and CERLA law requirements. The present invention also has a humanitarian impact by providing a way to educate people as to the risks associated with environmental harms and the seriousness of environmental issues in their lives and businesses.

The present scoring system, which is referred to commercially as the “EnviroScore®” scoring system, is an innovative approach to evaluating environmental liability associated with services and real property. The system allows banks to become “partners” in the theoretical sense. This is because the banks gain a mutual benefit and can make additional funds per transaction in terms of “fee income,” especially if banks choose to maximize profits by having a single environmental auditing company perform environmental audits for all loans processed in a bank for a reduced fee. This concept, referred to as a “bundling” or “across-the-board” approach, has not heretofore been applied in connection with environmental audits. One advantage of the bundling or across-the-board approach is that all environmental audits are performed by a single, unbiased, auditing company employing a standardized system of review. Therefore an entire bank's or lender's “portfolio” of loans would acquire this review process to be able to produce an aggregate score.

Scoring is a systematic approach that most bankers like and have become accustomed to using. The scoring approach is integrated into the generated report for interpretation by lenders and allows items that could be considered economically unfeasible to be reviewed with relative ease. The report can serve as an add-on to Environmental Phase I Reports. The report focuses on, but is not limited to, activities within the scope of state regulation.

The method categorizes the environmental risk associated with a business or piece of property into four distinct categories. Environmental risk is defined as the potential costs and/or liabilities that may be incurred in the future, discounted by the likelihood of such costs and/or liabilities actually occurring and immunity from future liability involving CERLA rules as required for any commercial property as prescribed to future property owners. The review is also closely aligned with the standard process as used in ASTM procedures for environmental review. A numerical score may be assigned to each of the four categories, or alternatively, may be assigned to the review as a whole. In addition, a specific code, color, or other indicator may be assigned either with the score or alone, for purposes of signifying a particular score or environmental condition. An indicator is particularly important because of the high turnover rate of loan officers. Thus, a simple indicator on an environmental audit makes it easy to both identify the level of environmental risk associated with a given property and retrain new loan officers in evaluating environmental audit reports.

A description of each category is set forth in the following paragraphs:

(1) Land associated risk. The first category pertains to the land or property on which the business stands. The environmental risk associated with the land is rated according to such criteria as: the environmental history of the land, the situs of the land, the proximity of the land to hazardous areas, proximity to environmental permits, proximity to requested subject sites as defined by the client, the use to which the land is put, the topography of the land, and other factors well known in the art, such as one or more factors set forth in the ASTM guidelines.

(2) Business or service associated risk. The second category pertains to the service operation of the business (otherwise referred to as SIC code). Factors that may influence this rating include the historical liability risk associated with the particular service(s), and other factors well known in the art. For example, a gasoline service station is a type of business that is known in the art to pose a high environmental risk, whereas a shopping center is a type of business that is generally considered to pose a low environmental risk.

(3) Current status or regulatory compliance. The third category pertains to the current status of regulatory compliance. This factor involves a review of the state and federal requirements, current permits, and other regulatory documents held by the business, evaluating compliance with each. For example, the existence of an outstanding enforcement action or the failure to submit discharge monitoring reports on a timely basis are two conditions that are likely to receive negative risk ratings in this category.

(4) Future regulatory compliance. The last category pertains to future requirements for regulatory compliance. This category requires the auditor to interpret and evaluate the amount and volume of compliance necessary in order to ensure maintenance and compliance with any permit issued or regulation promulgated by a regulatory agency as defined by regulations and SIC code.

In order to assess the risk associated with each of the above four categories, the auditor will necessarily have to assign risk to different pieces of information that are discovered within each category. Alternatively, a computer program may be utilized such that the auditor enters the information into the computer program and the computer program assigns a pre-determined amount of risk with each item of information entered. If a numerical score is used as a risk indicator, the scale may be any standardized scale, such as a scale from 0-100. If an alphabetical score is used as a risk indicator, then the scale may be any alphabetical character from A-Z, any combination thereof, or any combination of numerals and alphabetical characters. If a color coded scale is used, then the scale should range in color from dark, or subtle colors (indicating low risk) to bright colors (indicating heightened risk).

Regardless of the chosen indicator, the method of the present invention requires the auditor to assign a standard score, alphabetical reference, or color to common environmental problems. Alternatively, a computer program may be utilized such that the auditor enters the information into the computer program and the computer program assigns a pre-determined amount of risk with each item of information entered. For example, if a numerical scale of 0-100 is used, a score of minus ten (−10) may be assigned for an environmental enforcement action that is pending at the time of the review. The actual score could be higher or lower, depending on the severity of the particular enforcement action. The −10 score would be added to the other scores assigned for the “current status of regulatory compliance” category and a final score for that category would be tallied and included in the final report. Of course, the auditor may develop his or her own set of standard scores or a universal database of standardized scores may be developed for use by a pool of auditors or for a computer program implementing the invention. The computer program may also define the client's risk tolerances, additional parameters or method of delivery as a database. In an alternative embodiment, a computer may also be used to acquire and evaluate the data. Computer evaluation is necessary to provide a timely automated output and computation of the various data in order to perform a score. Delivery is also directed via computer and reports are stored as electronic copies for future retrieval.

The report generated according to the disclosed method may contain other information as well. It may provide an explanation of any low scores and may list the types of permits that may be required based upon the specific Standard Industrial Code (SIC) and type of business. The report may also list recommendations based on the review, including possible avenues of raising or nullifying existing concerns. The method also provides for the availability of discounted services for other needs, such as, permit applications, compliance and Best Management Plans (BMPs).

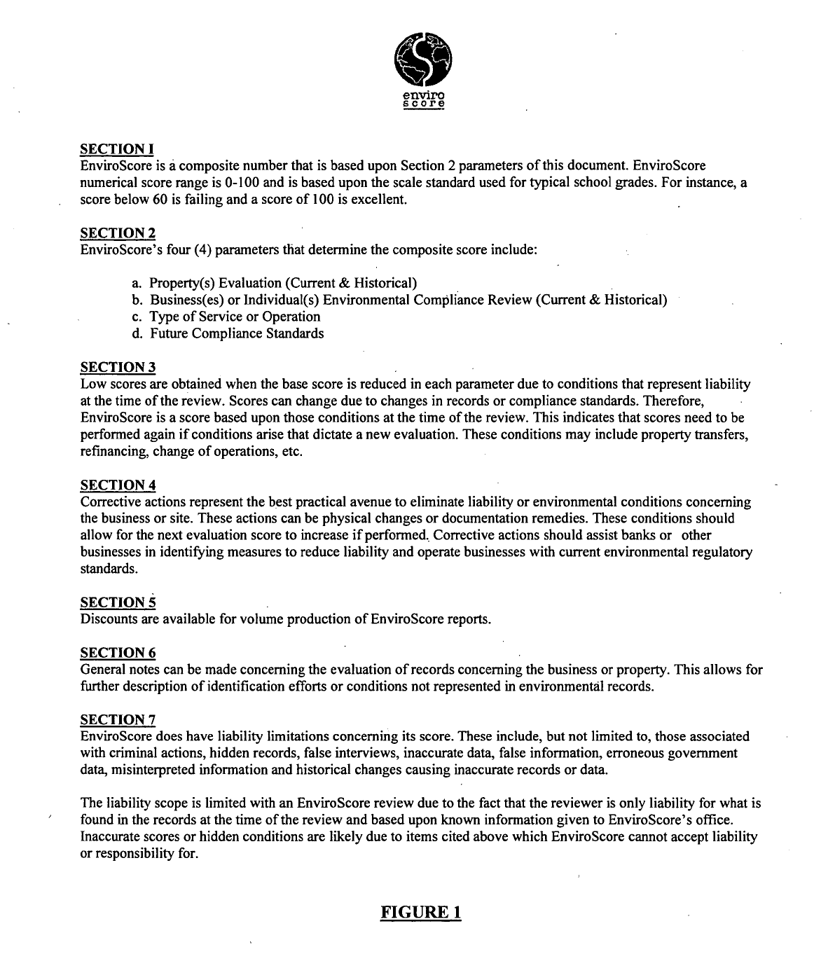

FIG. 1 shows a sample report generated according to one embodiment of the present invention. Section 1 shows the composite score of environmental risk. The composite may be arrived at in many different ways. For instance, a score (e.g., ranging from 0-100) for each of the four categories may be generated in a mechanical manner based on a checklist of items specific to each of the four categories. In one embodiment, the checklists may be based on the ASTM guidelines for environmental assessment reports and/or may include other items significant to a particular type of property or business. A final score may be achieved by averaging or adding each individual score within a category and then summing all categories to obtain the final score.

In an alternative embodiment, interim “raw” scores may be generated by either a computer or a technician, then reviewed and adjusted as necessary by a knowledgeable person who is familiar with all of the facts surrounding the property or business. Of course, the use of an additional person to review raw scores may make the environmental audit more arbitrary and slightly less reproducible than an audit performed without a final review official. However, final review may be necessary in order to highlight and address special circumstances that may arise.

Section 2 of the report in FIG. 1 shows a breakdown of the score according to each category. Section 3 contains a section for explanation of low marks. Section 4 provides a listing of the auditor's recommendations, which may be based on particular items noticed during the audit. Section 5 lists discounts, financial or otherwise, that are available to those who receive an audit according to the present invention. Section 6 is an area reserved for general notes, and Section 7 sets forth the various limitations of liability for the bank and the bank customer.

The audit will be tied to all commercial transactions at banks and added to the regular customary costs incurred by the client as part of the bank's closing costs. Some banks may allow the audit to be performed on a voluntary basis, or alternatively, the customer may be allowed to decline the environmental audit services. If the customer declines the audit services, the bank will likely insist on an appropriate waiver.

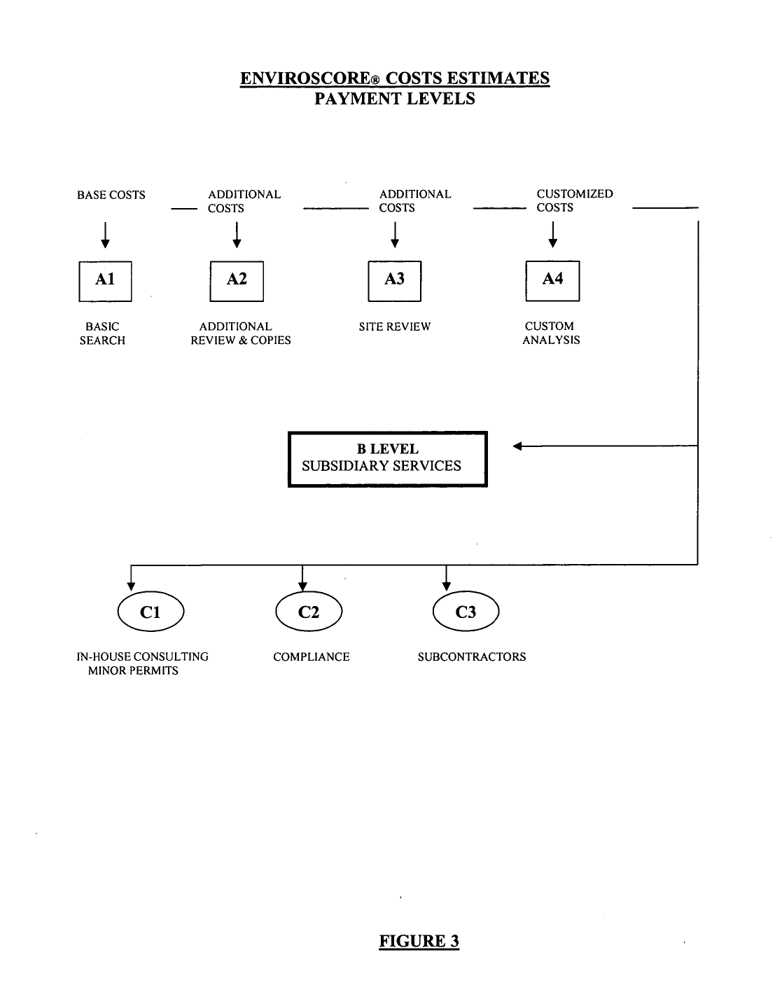

FIG. 3 shows how costs may be structured. The method may include three levels of services, shown here as A, B, and C. The core services are A level, subsidiary are B level, and secondary environmental needs are C level.

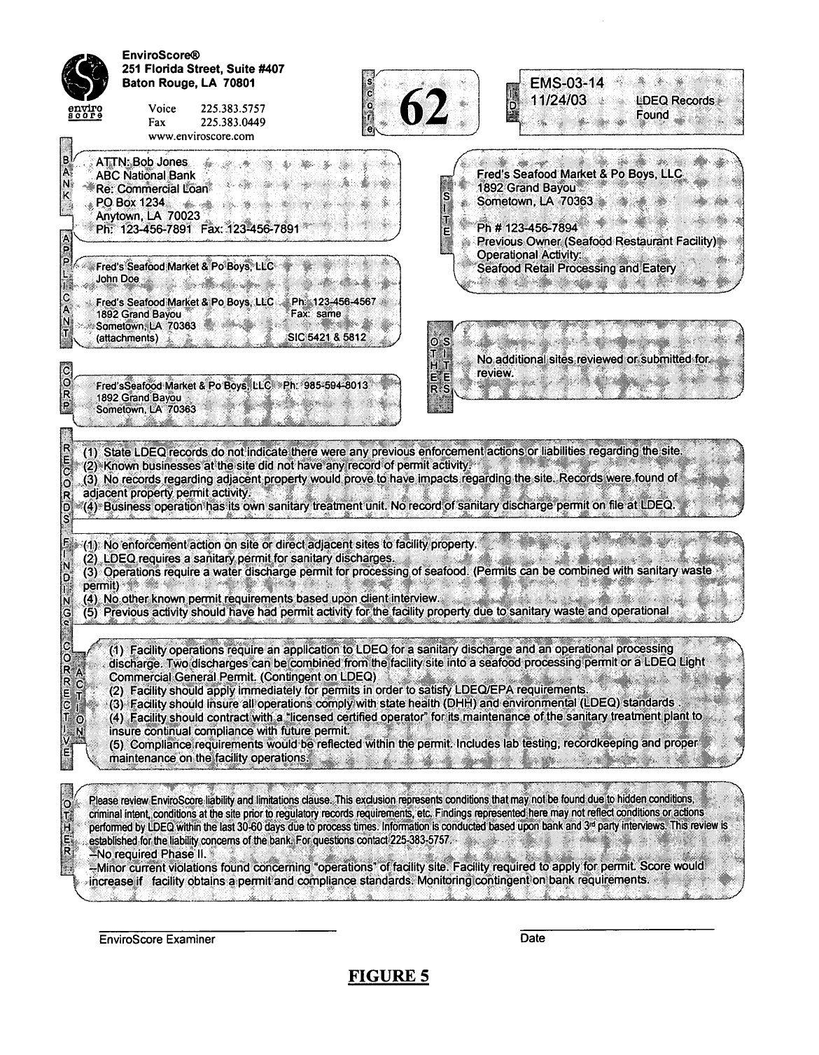

FIG. 5 shows an alternative format for the final report. In this embodiment, only the composite score is shown. Other sections displayed include records, findings, corrective action, and other.

The above described method is an innovative and pioneering approach to providing an overview of environmental liability and compliance for services and/or property. The score feature simplifies a business' understanding of potential environmental issues with a client. It is provided as an avenue to contain risk from environmental liability as environmental compliance and regulations become more complex on the state and federal levels. The method and report exceeds FDIC regulatory requirements and is designed in part to follow the FDIC environmental due diligence program.

The main emphasis of the method is to provide banks and their lenders (or insurance companies, venture capital groups, etc.) an opportunity to review a concise report before completing a transaction. The method could also be used by insurance companies, venture capital groups, Real estate Investment Trusts (REITs), retail business for siting criteria, etc. in evaluating the risk associated with the issuance of a particular policy, the purchase of a particular asset, etc. In the latter case, the score or indicator could be formulated upon review of all relevant indices, but may not always involve collateral review. The score for some industries will serve as an environmental credit review for businesses or individuals. If demand is sufficient, an “environmental audit database” could be established as a warehouse for the storage of environmental audit information relevant to a particular property or service. The environmental audit database would function in a manner similar to the Dunn & Bradstreet credit database, and environmental auditors could perform reviews of the database for customers as a lower priced alternative to obtaining a Phase I study or other standard environmental audit report.

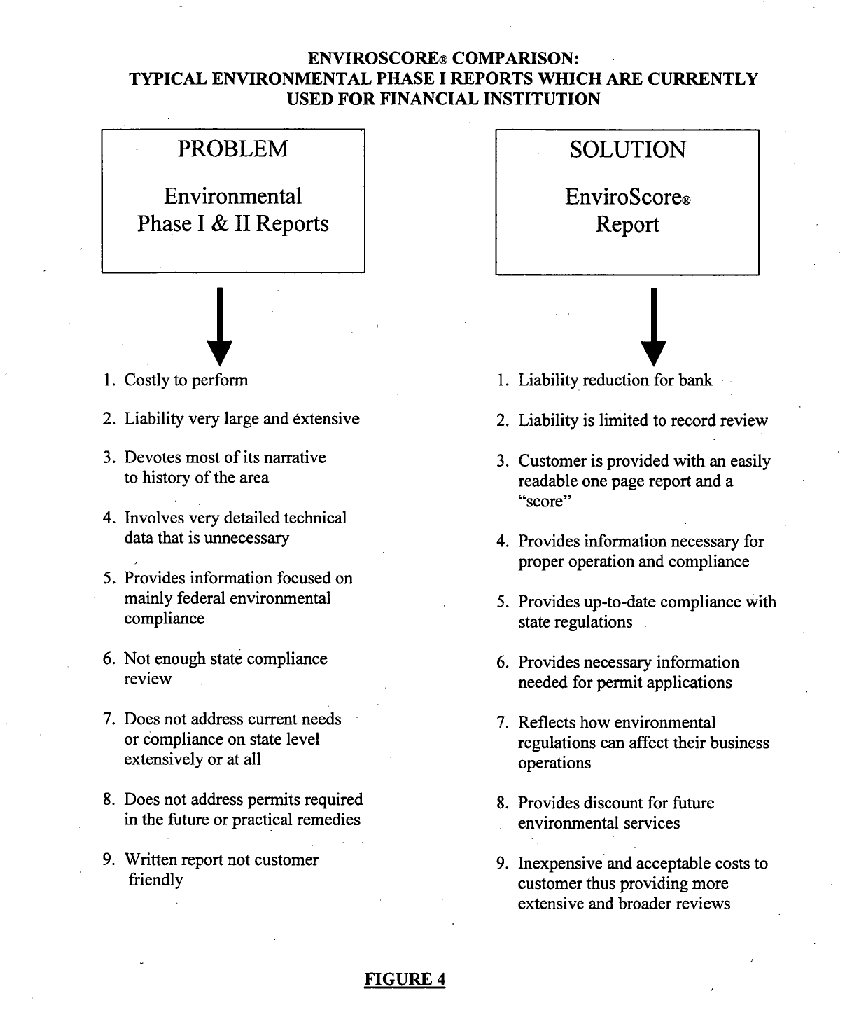

If the environmental audit method is used by a bank, then the cost of performing the audit may be paid by the client through closing costs. Some banks will consider the policy as voluntary—although the bank may require the client to sign a waiver exempting the bank from liability in such cases. This latter arrangement will curtail attempts to place liability with the bank for environmental problems and may lower bank liability premiums as a result. More than likely, clients will not exempt the bank from liability and will want to have the bank conduct the search for purposes of avoiding personal liability. These and various other advantages over and differences between the prior art are shown in FIG. 4.

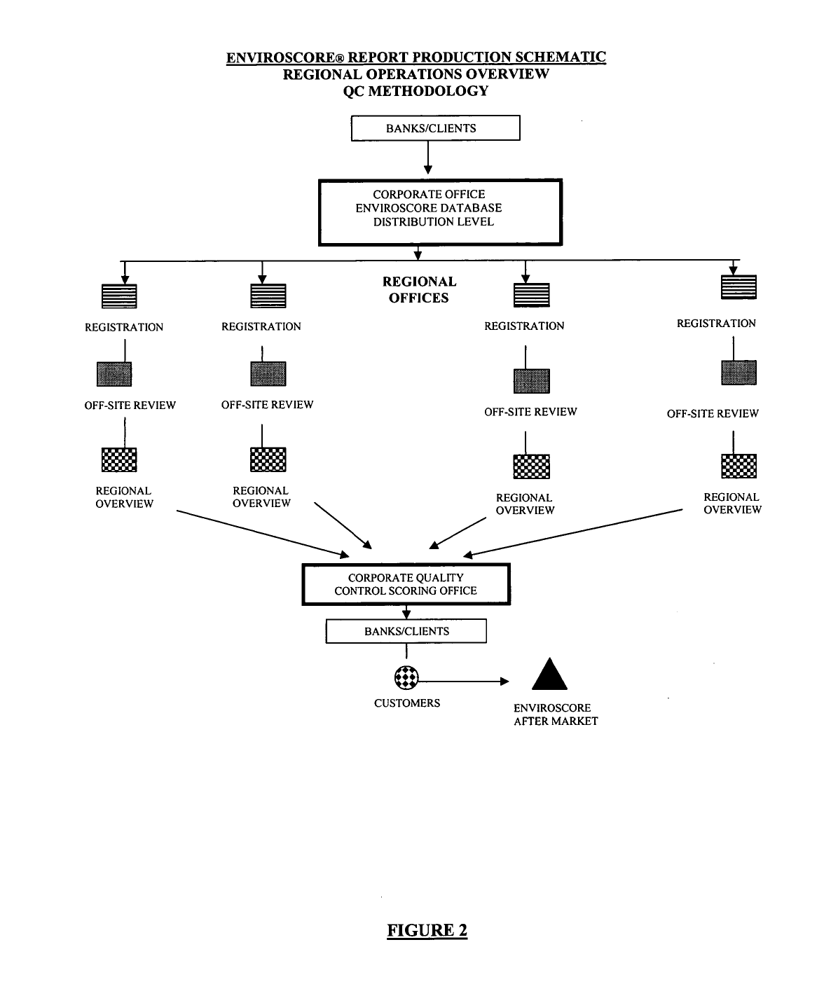

The costs of performing the environmental audit according to the present method will vary, depending upon the regional area in question, due to each state having its records system distributed over a wide array of offices. The bank may choose to increase or decrease the costs associated with the audit, depending on state laws, state policies, and local labor costs, all of which may affect the cost of performing the audit. These types of rate increases represent another advantage of the present invention, which effectively adds revenue to the bank. The method may utilize subcontractors or a corporate office may be established in all 50 states. FIG. 2 shows a schematic of report production, including a regional operations overview. The method is cost effective in that each report is generated based on the criteria most relevant to the property at issue. The research is concentrated so that it is tailored to the specific type of property. For example, the history of the land will determine how much time should be allocated to reviewing historical permitting and other data. If little time is needed in this area, the level of detail in other areas may be increased.

The method includes the use of an interactive web site that communicates with each banking and/or client's Internet or Internet system. The pertinent information and copies are sent to a database warehouse where auditing technicians will retrieve information and distribute it to the proper personnel, oftentimes on a need-to-know basis. Once the auditing staff receives information, it will be forwarded to a preliminary isolation system, which is devised to narrow the search based upon compliance and/or permit criteria within the region. In one embodiment, the preliminary isolation system involves the use of a computer program or headquarters auditing personnel to screen information and forward only the necessary information to regional offices, where the auditing services will be performed at the local level. This arrangement will ease the burden associated with the regional or local search. Alternatively, the information may be stored on a computer or multiple computers and may be accessed by auditors and auditing staff through the computer interface or through the internet.

The method of the invention also includes a system that will provide real-time review transmission via PDA tablet system, laptops, and other mobile devices to the database for submission of records reviewed and analysis of the search. The resulting record may be distributed to the headquarters office for further distribution of information to the bank, bank customer, or other affiliate of the financial institution. The scoring system simplifies to the greatest extent possible the environmental review for compliance liability.

Typical bank transactions have several items that are performed prior to closing or approval of the loan. For example, a credit report, title search, and/or insurance assessment and appraisal are usually performed prior to closing. Obviously, all of these factors are steps in the loan underwriting evaluation. If problems are perceived in these areas, then the lender is informed and either the issue is resolved or the bank declines the loan. If the risk is too high, the bank may decide not to grant the loan and lose any costs invested in the transaction prior to closing; however, the savings of the reduced liability by rejecting a risky loan application can be tremendous.

Increasingly, many banks have seen environmental liability occur mainly because of records discrepancies and not from the actual “physical exposure.” The mere nonsubmittal of proper records or missing records by a regulated entity can increase the liability associated with a particular transaction, because it provides an informational void in the compliance history, which may be interpreted as a liability, even if no environmental issues exist at the site. Paperwork discrepancies can account for loans not being renewed or a rejection by another bank for refinancing. This can prove disastrous for the bank client and the bank itself.

Even environmental consultants have a difficult time with multi-media issues. Nevertheless, lay people as well as consultants are charged with the task of learning and understanding the environmental statutes, rules, and policies on their own, which is a truly daunting task. As described above, the foregoing system provides a method to simplify the technical jargon and assist banks, clients, and consultants in addressing this problem and reaching a streamlined and efficient solution.

There are of course alternate embodiments that are obvious from the foregoing descriptions of the invention, which are intended to be included within the scope of the invention, as defined by the following claims.

I claim:

1. A method for performing an environmental audit in connection with a transaction, comprising the steps of:
assessing the environmental risk associated with a business, said environmental risk comprising the environmental risk associated with a piece of land, a service operation, a current state of regulatory compliance, and the future requirements for regulatory compliance;
assigning a first indicator to said environmental risk associated with said piece of land;
assigning a second indicator to said environmental risk associated with said service operation;
assigning a third indicator to said environmental risk associated with said current state of regulatory compliance;
assigning a fourth indicator to said environmental risk associated with said future requirements for regulatory compliance; and
generating a report including said first, second, third, and fourth indicators.

2. The method of claim 1, wherein said transaction is selected from the group consisting of a loan transaction, an insurance transaction, or a venture capital transaction.

3. The method of claim 2, wherein an entity facilitating said loan transaction, said insurance transaction, or said venture capital transaction charges its client a fee for said report that is greater in value than the fee paid by said entity for said environmental audit.

4. The method of claim 1, wherein said first, second, third, and fourth indicators are numerical scores.

5. The method of claim 4, wherein said report further includes a final indicator, said final indicator comprised of the sum of said first, second, third, and fourth indicators.

6. The method of claim 4, wherein said numerical scores for each of said first, second, third, and fourth indicators are obtained by summing the values of a plurality of interim indicators, said interim indicators being generated by a computer.

7. The method of claim 6, wherein said plurality of interim indicators are derived from ASTM guidelines.

8. The method of claim 1, wherein said first, second, third, and fourth indicators are reviewed and adjusted by a knowledgeable person.

9. The method of claim 1, wherein said first, second, third, and fourth indicators are colors.

10. The method of claim 9, wherein said report includes a final indicator, said final indicator comprised of the combination of said first, second, third, and fourth indicators.

11. The method of claim 1, wherein said report includes a final indicator, said final indicator comprised of the combination of said first, second, third, and fourth indicators.

12. The method of claim 11, wherein said report further includes a final indicator, said final indicator comprised of the sum of said first, second, third, and fourth indicators.

13. The method of claim 1, wherein said report further comprises an explanation of low scores achieved.

14. The method of claim 1, wherein said report further comprises a listing of required environmental permits.

15. The method of claim 1, wherein said report further comprises a list of corrective action recommendations based on said audit.

16. The method of claim 1, wherein said environmental risk associated with said current state of regulatory compliance is determined by a computer program.

17. The method of claim 16, wherein said computer program forwards said environmental risk associated with said current state of regulatory compliance to an environmental auditor.

18. A method for performing an environmental audit to accompany a loan transaction, comprising:
an environmental auditor performing an evaluation of environmental risk for a financial institution capable of rendering financial assistance;
wherein said financial institution comprises individual customers in need of said financial assistance from said financial institution, each of said customers being willing and able to grant rights in the collateral for said loan transaction to said financial institution in exchange for said financial assistance;
wherein said evaluation comprises the environmental risk associated with said collateral proffered by each of said customers in said population; and
wherein, said environmental auditor is able to evaluate said environmental risk for each of said collateral at a unit price that is lower than the unit price of said financial institution for evaluating said environmental risk for a single customer.

19. The method of claim 18, wherein said environmental auditor evaluates said risk associated with said collateral using a universal environmental auditing method.

20. The method of claim 19, wherein said universal environmental auditing method comprises the following steps:
assessing the environmental risk associated with a business, said environmental risk comprising the environmental risk associated with a piece of land, a service operation, a current state of regulatory compliance, and the future requirements for regulatory compliance;
assigning a first indicator to said environmental risk associated with said piece of land;
assigning a second indicator to said environmental risk associated with said service operation;
assigning a third indicator to said environmental risk associated with said current state of regulatory compliance;
assigning a fourth indicator to said environmental risk associated with said future requirements for regulatory compliance; and
generating a report including said first, second, third, and fourth indicators.

21. The method of claim 18, wherein said financial institution charges each of said customers a fee for said environmental audit that is greater in value than the fee paid by said financial institution for said environmental audit.

22. The method of claim 18, wherein said environmental auditor employs personnel at one or more regional offices and at a headquarters, wherein at least a portion of said environmental audit is carried out by said personnel at said regional office and reported back to said personnel at said headquarters.

23. The method of claim 18, wherein said report is automatically transmitted to a database through a device selected from the group consisting of a PDA tablet system, laptop computer, and mobile device.

24. A method for performing an environmental audit, comprising:
an environmental auditor performing an evaluation of environmental risk associated for an insurance company capable of issuing insurance policies;
wherein said insurance company comprises individual customers in need of said insurance policies from said insurance company, each of said customers being involved in a business operation;
wherein said evaluation of environmental risk is associated with said business operations of said customers;
said environmental risk comprising the current state of regulatory compliance; and
wherein, said environmental auditor is able to evaluate said environmental risk associated with each of said business operations at a unit price that is lower than the unit price of said insurance company for evaluating said environmental risk for a single business operation.

25. A method for performing an environmental audit, comprising the steps of:
providing a central database, said central database containing information pertaining to the environmental risk associated with a piece of land or service, said environmental risk comprising the current state of regulatory compliance;
searching said central database in order to evaluate said environmental risk associated with said piece of land or said service; and
generating a report summarizing said environmental risk associated with said piece of land or said service.
